(19) United States
(12) Patent Application Publication
(10) Pub. No.: US 2025/0351082 A1
(43) Pub. Date: Nov. 13, 2025

(54) BIT ORDERING FOR WIRELESS SIGNALING USING MULTIPLE TYPES OF WAVEFORMS

(71) Applicant: QUALCOMM Incorporated, San Diego, CA (US)

(72) Inventors: Huilin XU, Temecula, CA (US); Nicolas CORNILLET, Lannion (FR)

(21) Appl. No.: 19/089,963

(22) Filed: Mar. 25, 2025

Related U.S. Application Data
(60) Provisional application No. 63/644,889, filed on May 9, 2024.

(51) Int. Cl. H04W 52/02; H04L 27/02

(52) U.S. Cl. CPC H04W 52/0235; H04L 27/02

(57) ABSTRACT

Methods, systems, and devices for wireless communications are described. In some examples, a user equipment (UE) may receive wireless signaling including a first wireless signal and a second wireless signal during a same time duration. The first wireless signal and the second wireless signal may carry the same information. For example, the first wireless signal may be an on off keying (OOK) signal and the second wireless signal may be an orthogonal frequency division multiplexing (OFDM) signal. The OFDM signal may include one or more OFDM sequences overlaid on the on durations of the OOK signal. The ODFM signal may carry the same bits as the OOK signal, but in a different (e.g., reverse) order.

### CROSS REFERENCES

The present Application for Patent claims benefit of U.S. Provisional Patent Application No. 63/644,889 by X U et al., entitled “BIT ORDERING FOR WIRELESS SIGNALING USING MULTIPLE TYPES OF WAVEFORMS,” filed May 9, 2024, assigned to the assignee hereof, and expressly incorporated herein.

### FIELD OF TECHNOLOGY

The following relates to wireless communications, including bit ordering for wireless signaling using multiple types of waveforms.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include monitoring for wireless signaling during a set of multiple on-off keying (OOK) symbols, receiving, based on the monitoring, the wireless signaling including an OOK signal including one or more on durations and one or more off durations within the set of multiple OOK symbols and an orthogonal frequency division multiplexing (OFDM) signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol, and decoding a wireless message including at least a portion of the first set of multiple bits, at least a portion of the second set of multiple bits, or both, based on receiving the wireless signaling including the OOK signal and the OFDM signal.

A UE for wireless communications is described. The UE may include one or more memories storing processor executable code, and one or more processors coupled with the one or more memories. The one or more processors may individually or collectively be operable to execute the code to cause the UE to monitor for wireless signaling during a set of multiple OOK symbols, receive, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol, and decode a wireless message including at least a portion of the first set of multiple bits, at least a portion of the second set of multiple bits, or both, based on receiving the wireless signaling including the OOK signal and the OFDM signal.

Another UE for wireless communications is described. The UE may include means for monitoring for wireless signaling during a set of multiple OOK symbols, means for receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol, and means for decoding a wireless message including at least a portion of the first set of multiple bits, at least a portion of the second set of multiple bits, or both, based on receiving the wireless signaling including the OOK signal and the OFDM signal.

A non-transitory computer-readable medium storing code for wireless communications is described. The code may include instructions executable by one or more processors to monitor for wireless signaling during a set of multiple OOK symbols, receive, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol, and decode a wireless message including at least a portion of the first set of multiple bits, at least a portion of the second set of multiple bits, or both, based on receiving the wireless signaling including the OOK signal and the OFDM signal.

In some examples of the method, UEs, and non-transitory computer-readable medium described herein, the second set of multiple bits includes the first set of multiple bits in reverse order according to the reordering such that the first set of multiple bits includes an ascending order of a set of bits and the second set of multiple bits includes a descending order of the set of bits.

In some examples of the method, UEs, and non-transitory computer-readable medium described herein, the first set of multiple bits includes a first set of segments and the second set of multiple bits includes a second set of segments and the second set of segments includes the first set of segments in reverse order according to the reordering.

In some examples of the method, UEs, and non-transitory computer-readable medium described herein, a quantity of bits in the subset of the second set of multiple bits occurring in the first OOK symbol may be greater than a quantity of bits in the subset of the first set of multiple bits occurring in the first OOK symbol.

In some examples of the method, UEs, and non-transitory computer-readable medium described herein, a quantity of bits in the subset of the second set of multiple bits occurring in the first OOK symbol may be equal to a quantity of bits in the subset of the first set of multiple bits occurring in the first OOK symbol.

In some examples of the method, UEs, and non-transitory computer-readable medium described herein, receiving the wireless signaling may include operations, features, means, or instructions for receiving the OFDM signal during a first portion of the set of multiple OOK symbols, where the second set of multiple bits includes the reordering of the first set of multiple bits occurs within the first portion of the set of multiple OOK symbols.

Some examples of the method, UEs, and non-transitory computer-readable medium described herein may further include operations, features, means, or instructions for ignoring at least a portion of the OOK signal during at least a second portion of the set of multiple OOK symbols occurring after the first portion of the set of multiple OOK symbols.

Some examples of the method, UEs, and non-transitory computer-readable medium described herein may further include operations, features, means, or instructions for entering a power saving mode during at least a second portion of the set of multiple OOK symbols occurring after the first portion of the set of multiple OOK symbols.

In some examples of the method, UEs, and non-transitory computer-readable medium described herein, the OFDM signal located within the one or more on durations of the OOK signal includes one of a set of multiple candidate OFDM waveforms, each candidate OFDM waveform corresponding to respective portion of a bitstream.

In some examples of the method, UEs, and non-transitory computer-readable medium described herein, receiving the wireless signaling may include operations, features, means, or instructions for receiving a first portion of the OOK signal during a first portion of the set of multiple OOK symbols, the first portion of the OOK signal including a first portion of the first set of multiple bits and receiving a first portion of the OFDM signal during the first portion of the set of multiple OOK symbols, the second portion of the OFDM signal including a first portion of the second set of multiple bits.

Some examples of the method, UEs, and non-transitory computer-readable medium described herein may further include operations, features, means, or instructions for combining the first portion of the first set of multiple bits with the first portion of the second set of multiple bits, where the first portion of the first set of multiple bits includes a first portion of the wireless message and the first portion of the second set of multiple bits includes a second portion of the wireless message according to the reordering, and where decoding the wireless message may be based on the combining.

Some examples of the method, UEs, and non-transitory computer-readable medium described herein may further include operations, features, means, or instructions for ignoring a second portion of the OOK signal and a second portion of the OFDM signal during a second portion of the set of multiple OOK symbols occurring after the first portion of the set of multiple OOK symbols based on the receiving.

Some examples of the method, UEs, and non-transitory computer-readable medium described herein may further include operations, features, means, or instructions for entering a power saving mode during a second portion of the set of multiple OOK symbols occurring after the first portion of the set of multiple OOK symbols.

Some examples of the method, UEs, and non-transitory computer-readable medium described herein may further include operations, features, means, or instructions for receiving control signaling indicating the reordering, where decoding the wireless message may be based on the control signaling indicating the reordering.

Some examples of the method, UEs, and non-transitory computer-readable medium described herein may further include operations, features, means, or instructions for entering a low power sleep mode according to a power saving configuration, monitoring for the wireless signaling including a low-power wakeup signal via a low-power wakeup radio according to a low power monitoring mode, where receiving the wireless signaling may be based on the monitoring and the decoding occurs within a first portion of the set of multiple OOK symbols based on the reordering, and re-entering the low power sleep mode during a second portion of the set of multiple OOK symbols occurring after the first portion of the set of multiple OOK symbols.

A method for wireless communications by a UE is described. The method may include receiving a first wireless signal and a second wireless signal during a same time duration, where the first signal and the second signal each carry the same information and decoding at least a portion of the first wireless signal, or at least a portion of the second wireless signal, or both.

A UE for wireless communications is described. The UE may include one or more memories storing processor executable code, and one or more processors coupled with the one or more memories. The one or more processors may individually or collectively be operable to execute the code to cause the UE to receive a first wireless signal and a second wireless signal during a same time duration, where the first signal and the second signal each carry the same information and decode at least a portion of the first wireless signal, or at least a portion of the second wireless signal, or both.

Another UE for wireless communications is described. The UE may include means for receiving a first wireless signal and a second wireless signal during a same time duration, where the first signal and the second signal each carry the same information and means for decoding at least a portion of the first wireless signal, or at least a portion of the second wireless signal, or both.

A non-transitory computer-readable medium storing code for wireless communications is described. The code may include instructions executable by one or more processors to receive a first wireless signal and a second wireless signal during a same time duration, where the first signal and the second signal each carry the same information and decode at least a portion of the first wireless signal, or at least a portion of the second wireless signal, or both.

In some examples of the method, UEs, and non-transitory computer-readable medium described herein, the first wireless signal may be received via first bandwidth, may be scrambled according to a first scrambling sequence, may be encoded according to a first encoding procedure, may be modulated by a first modulation scheme, or any combination thereof and the second wireless signal may be received via a second bandwidth that may be different than the first bandwidth, may be scrambled according to a second scrambling sequence that may be different than the first scrambling sequence, may be encoded according to a second encoding procedure that may be different than the first encoding procedure, may be modulated by a second modulation scheme that may be different than the first modulation scheme, or any combination thereof.

In some examples of the method, UEs, and non-transitory computer-readable medium described herein, the first modulation scheme includes an on-off key (OFF) modulation scheme, and the second modulation scheme includes an orthogonal frequency division modulation (OFDM) modulation scheme.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports bit ordering for wireless signaling using multiple types of waveforms in accordance with one or more aspects of the present disclosure.

FIG. 2 shows an example of a timeline that supports bit ordering for wireless signaling using multiple types of waveforms in accordance with one or more aspects of the present disclosure.

FIG. 3 shows an example of a timeline that supports bit ordering for wireless signaling using multiple types of waveforms in accordance with one or more aspects of the present disclosure.

FIG. 4 shows an example of a timeline that supports bit ordering for wireless signaling using multiple types of waveforms in accordance with one or more aspects of the present disclosure.

FIG. 5 shows an example of a timeline that supports bit ordering for wireless signaling using multiple types of waveforms in accordance with one or more aspects of the present disclosure.

FIG. 6 shows an example of a process flow that supports bit ordering for wireless signaling using multiple types of waveforms in accordance with one or more aspects of the present disclosure.

FIGS. 7 and 8 show block diagrams of devices that support bit ordering for wireless signaling using multiple types of waveforms in accordance with one or more aspects of the present disclosure.

FIG. 9 shows a block diagram of a communications manager that supports bit ordering for wireless signaling using multiple types of waveforms in accordance with one or more aspects of the present disclosure.

FIG. 10 shows a diagram of a system including a device that supports bit ordering for wireless signaling using multiple types of waveforms in accordance with one or more aspects of the present disclosure.

FIGS. 11 through 14 show flowcharts illustrating methods that support bit ordering for wireless signaling using multiple types of waveforms in accordance with one or more aspects of the present disclosure.

### DETAILED DESCRIPTION

In some examples, a network entity may be capable of transmitting multiple wireless signals via the same wireless signaling. For example, the network entity may be able to overlay one wireless signal (e.g., one or more sequences encoded according to a first modulation scheme) over another wireless signal. For instance, a wireless message may be an example of a low power wakeup signal (LP-WUS) including an on-off keying (OOK) signal. The OOK signaling may include on durations (e.g., during which energy is detected by a user equipment (UE)) and off durations (e.g., in which no energy is detected by the UE). The presence, or location, or both, of energy within an OOK symbol may carry one or more bits. The network entity may also overlay one or more sequences (e.g., orthogonal frequency division multiplexing (OFDM) sequences) and transmit the sequences via the on durations of the OOK symbol.

In some examples, the UE may receive wireless signaling including a first wireless signal and a second wireless signal during a same time duration. The first wireless signal and the second wireless signal may carry the same information. For example, the first wireless signal may be an OOK signal and the second wireless signal may be an OFDM signal. The OFDM signal may include one or more OFDM sequences overlaid on the on durations of the OOK signal. The ODFM signal may include the same bits as the OOK signal, but in a different (e.g., reverse) order.

In some examples, the bit sequence of the OOK signal may be first segmented, and the segments may be reversed such that the OFDM signal is the segments of the OOK signal in reverse order. In some examples, the bit sequence of the OOK signal may be first reversed and then segmented such that the OFDM signal is the reverse of the full bit sequence of the OOK signal. The UE may receive the OFDM signal in less time than the OOK signal if the OFDM signal conveys more bits in less time (e.g., with four or more candidate OFDM sequences, each OFDM sequence may indicate two or more bits during an on duration that only conveys one bit via the OOK signal). In some examples, the OFDM signal and the OOK signal may carry the same information in reverse order (e.g., but the OFDM signal be based on two candidate OOK sequences). In such examples, the UE may receive a first portion of the wireless message (e.g., the LP-WUS) via the OOK signal, and a second portion of the wireless message via the OFDM signal (e.g., because the OFDM signal carries the same bits as the OOK signal, just in reverse order). The UE may combine the first and second portions of the wireless message.

By performing one or more techniques described herein including receiving the OFDM signal faster than then OOK signal, or by combining portions of the OOK and OFDM signal, the UE may receive the wireless message in less time than the duration of the message (e.g., faster than the full duration of the LP-WUS), in which case the UE may enter a low power mode and conserve power.

Aspects of the disclosure are initially described in the context of wireless communications systems. Aspects of the disclosure are further illustrated by and described with reference to timelines and process flows. Aspects of the disclosure are further illustrated by and described with reference to apparatus diagrams, system diagrams, and flowcharts that relate to bit ordering for wireless signaling using multiple types of waveforms.

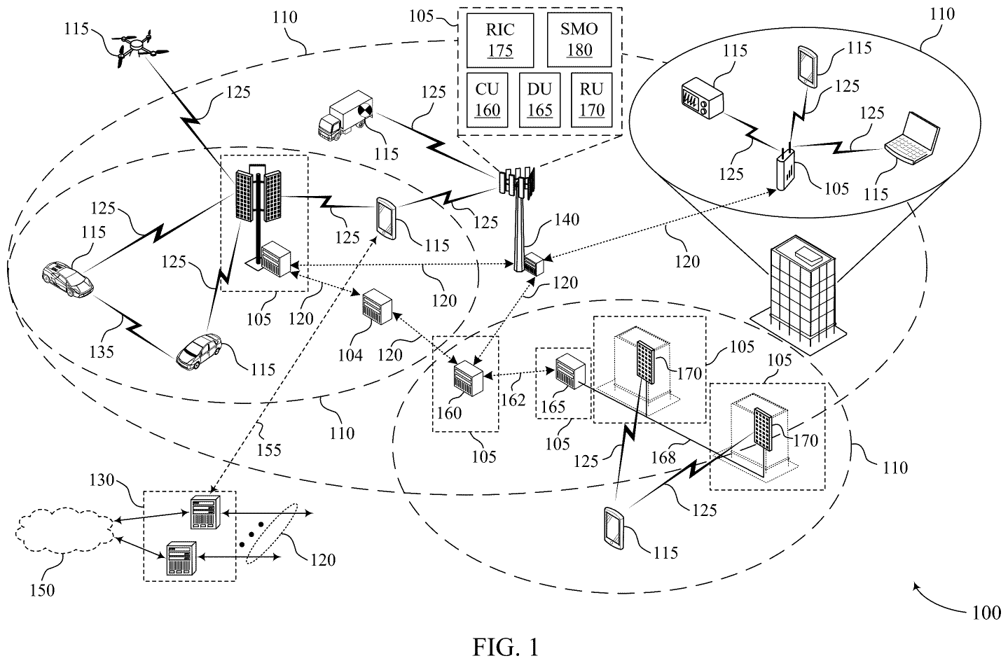

FIG. 1 shows an example of a wireless communications system 100 that supports bit ordering for wireless signaling using multiple types of waveforms in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the UE may receive wireless signaling including a first wireless signal and a second wireless signal during a same time duration. The first wireless signal and the second wireless signal may carry the same information. For example, the first wireless signal may be an OOK signal and the second wireless signal may be an OFDM signal. The OFDM signal may include one or more OFDM sequences overlaid on the on durations of the OOK signal. The ODFM signal may include the same bits as the OOK signal, but in a different (e.g., reverse) order.

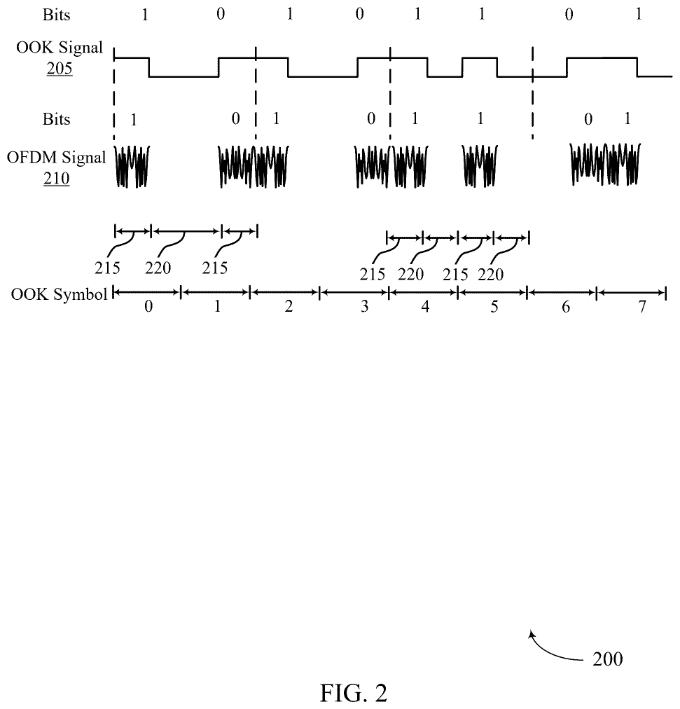

FIG. 2 shows an example of a timeline 200 that supports bit ordering for wireless signaling using multiple types of waveforms in accordance with one or more aspects of the present disclosure. The timeline 200 may implement, or be implemented by, aspects of the wireless communications system 100. For example, a UE (e.g., a UE 115) and a network entity (e.g., a network entity 105), which may be examples of corresponding devices described with reference to FIG. 1, may communicate with each other according to the timeline 200.

The network entity (e.g., or another wireless device) may transmit a wireless signal. In some examples, the network entity may transmit the wireless signal via OOK modulation (e.g., an OOK signal 205). The network entity may also overlay one or more OFDM sequences on the wireless signal. The OOK signal 205 may be an example of any type of wireless signaling, such as a low-power wakeup signal (LP-WUS). The wireless signal (e.g., the LP-WUS) may include the OOK signal (e.g., an OOK envelope), and one or more OFDM sequences. For example, the OOK envelope may include a set of OOK symbols (e.g., OOK symbol 0, OOK symbol 1, OOK symbol 2, OOK symbol 3, OOK symbol 4, OOK symbol 5, OOK symbol 6, and OOK symbol 7). In some examples, each OFDM symbol may include more than one (e.g., two) OOK symbols. The OOK signal 205 may indicate information (e.g., a bit value) based on the presence of energy (e.g., during an on duration 215, which may be referred to as an OOK on symbol) or the absence of energy (e.g., during an off duration 220, which may be referred to as an OOK off symbol). In some examples, each OOK symbol may indicate a 1 or a 0 (e.g., if energy is detected by a receiving device such as the UE, then the OOK signal 205 may indicate a 1 for the OOK symbol, and if no energy is detected by the receiving device, then the OOK signal 205 may indicate a 0 for the OOK symbol). In some examples, additional coding may be applied (e.g., Manchester coding), in which case a position of an on duration 215 in an OOK symbol indicates the information bit. For instance, an on duration 215 followed by an off duration 220 (e.g., in the OOK symbol 0) may indicate a 1, and an off duration 220 followed by an on duration 215 (e.g., in the OOK symbol 1) may indicate a 0 (e.g., such that the first OOK symbol 0 and the second OOK symbol 1 indicates a bit sequence of 1 0). Similarly, an on duration 215 followed by an off duration 220 (e.g., in the OOK symbol 4) may indicate a 1, and another on duration 215 followed by another off duration 220 in the OOK symbol 5 may indicate another 1 (e.g., such that the fifth OOK symbol 4 and the sixth OOK symbol 5 indicates a bit sequence of 1 1). Thus, the OOK signal may carry a sequence of bits based on the presence, or location, of energy (e.g., on durations 215 and off durations 220) within each OOK symbol (e.g., the OOK signal 205 may indicate, across eight OOK symbols, a bit sequence of 10101101).

In some examples, the transmitting device (e.g., the network entity) may overlay an OFDM signal 210 onto the wireless signal. For example, an OFDM sequence can be transmitted within each OOK on portion (e.g., each OOK on duration 215). A quantity of bits conveyable by the OFDM sequences may depend on a quantity of candidate OFDM sequences selectable by the UE. For example, if the network entity is capable of selecting (e.g., or if the receiving UE is capable of receiving) two different candidate OFDM sequences, then each sequence may indicate a bit value (e.g., 1 or 0). In some examples, each bit may correspond to one bit of a bitmap, or one symbol of a binary sequence containing multiple symbols. Thus, as illustrated with reference to the timeline 200, the OFDM signal 210 may convey the same information as the OOK signal 205. In some examples, the OFDM signal 210 may convey the same bits, in the same order, as the OOK signal 205 (e.g., a first waveform located during the first on duration 215 of OOK symbol 0 may indicate a 1, and a second waveform located in the final on duration 215 of OOK symbol 1 may indicate a 0). In such examples, the OFDM sequence carries a single bit of information by one of two candidate sequences, and the bit order for the OOK signal 205 and the OFDM signal 210 is not changed, in which case the receiving device may be unable to perform early detection of the wireless signal (e.g., there is no way for the receiving device to perform early detection).

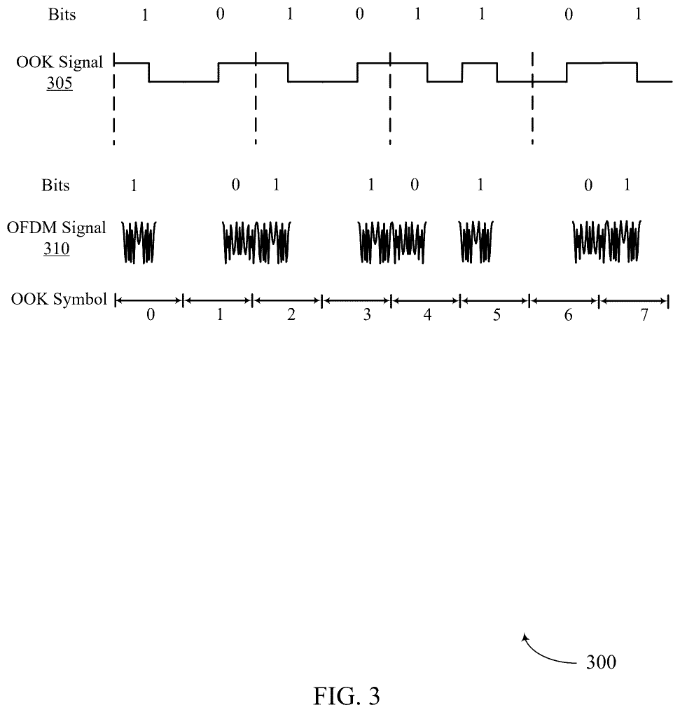

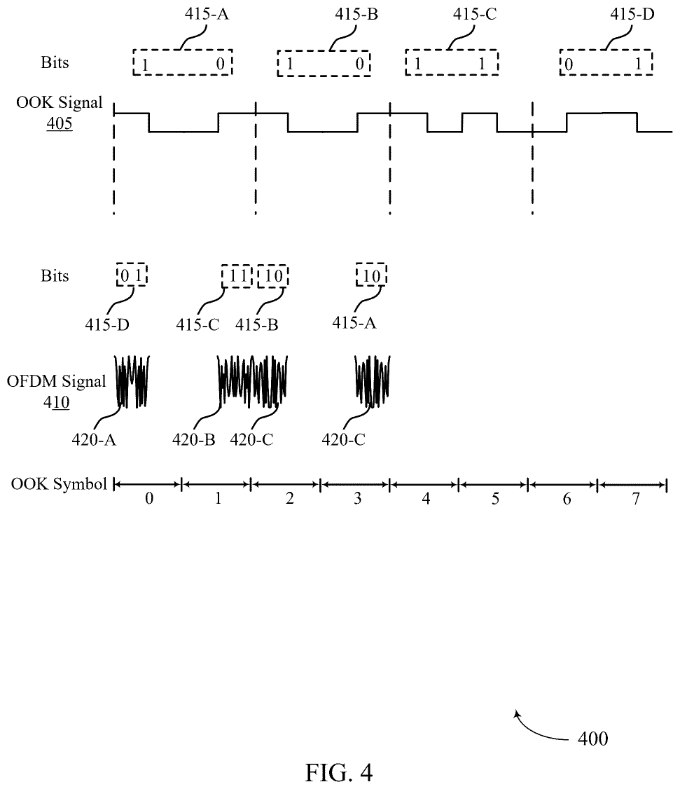

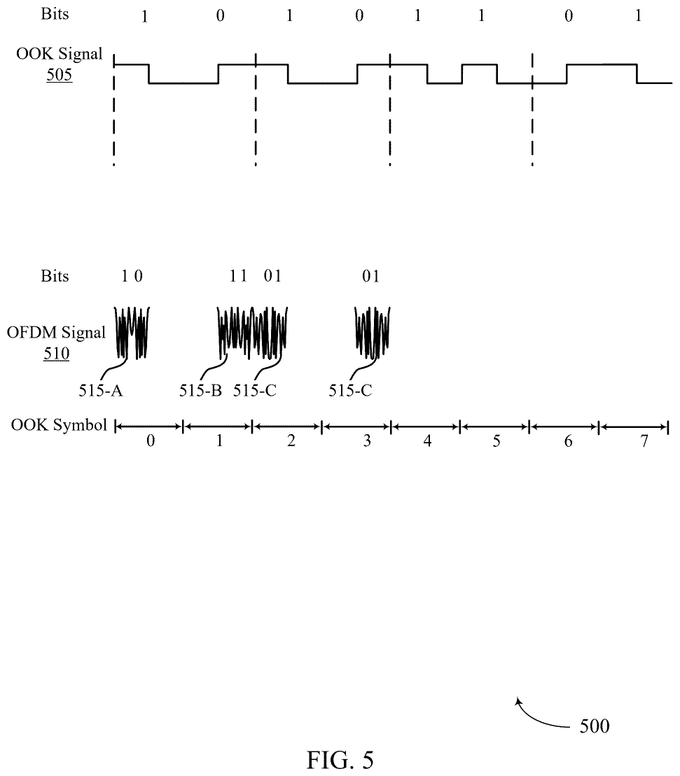

In some examples (e.g., as described in greater detail with reference to FIGS. 4-5), the network entity (e.g., or the UE) may support more than two candidate sequences per OOK on portion, in which case more than 1 bit of information can be transmitted within each OOK on duration 215. For example, if one of four candidate OFDM sequences is overlaid with an on duration 215, then the OFDM sequence may indicate two bits (e.g., instead of 1). In such examples, the same information conveyed by the OOK signal 205 could be conveyed via the OFDM signal 210 during the on durations 215 of each OOK symbol, in which case the UE may successfully receive the same information via the OFDM signal in less time (e.g., four OOK symbols, instead of eight OOK symbols, or two OFDM symbols instead of four OFDM symbols). Similarly, the same information may be included in both the OOK signal 205 and the OFDM signal 210, but the bits may be reordered. For instance (e.g., as described with reference to FIG. 3), the bits of an OFDM signal 310 may be the same as the bits in an OOK signal 305, in reverse order, in which case the UE may receive the first portion (e.g., first half) of the OOK signal 305 (e.g., in the first four OOK symbols) and the second portion (e.g., second half) of the same bits via the OFDM signal 310 (e.g., during the first four OOK symbols). The first half and the second half of the same bit sequence may then be combined by the receiving device (e.g., the UE), resulting in receiving the full bit sequence in half the time.

Thus, as described herein, a receiving device (e.g., a UE) may receive a wireless message (e.g., a LP-WUS) from the OOK symbols and the overlaid OFDM sequences, resulting in faster detection of the LP-WUS and increased power savings. Receiving the same information in less time (e.g., by receiving more bits per OOK symbol via the OFDM signal as described in greater detail with reference to FIGS. 4-5, or by receiving part of the bit sequence via the OOK signal and part of the bit sequence via the OFDM signal) may result in increased power savings (e.g., the UE can receive an LP-WUS in less time, go back to sleep, and conserve more power), increased throughput, or decreased system latency, among other examples. Bit ordering (e.g., when the bit sequence has been reversed or otherwise changed) may be utilized for decoding the received signal. For example, the transmitting device (e.g., the network entity) may purposefully organize bits in the OOK symbols and the overlaid sequences in such a way that a union (e.g., combination) of bits collected from a first set of M OFDM symbols provide full information (e.g., a full LP-WUS message), and such that a quantity of M is decreased. For instance, in examples described with reference to FIGS. 3-5, M=4, in which case each OFDM symbol contains 2 OOK symbols (e.g., where M corresponds to a quantity of chips, each corresponding to one OOK symbol or one OOK OFF symbol in the OFDM symbol). Techniques for ordering the bit sequence accordingly are described herein. The ordering of the bit sequence may be predefined, defined in one or more standard documents, or indicated to the receiving device (e.g., the UE) via control signaling, among other examples.

According to techniques described herein, each overlaid OFDM sequence (e.g., of the OFDM signal 210) may be transmitted in an OOK on portion (e.g., an on duration 215, which may be referred to as an OOK on chip, or a symbol duration). In some examples (e.g., an LP-WUS design), each overlaid OFDM sequence may also be transmitted in an OOK symbol (e.g., an off portion is also included in the overlaid sequence), during multiple OOK on symbols, multiple OOK symbols, or via one or more OFDM symbols. In some examples, the wireless message (e.g., the LP-WUS) may contain a bit sequence, and the bits may be encoded by error correction coding, or cyclic redundancy check (CRC) encoding, among other examples.

FIG. 3 shows an example of a timeline 300 that supports bit ordering for wireless signaling using multiple types of waveforms in accordance with one or more aspects of the present disclosure. The timeline 300 may implement, or be implemented by, aspects of the wireless communications system 100, or the timeline 200. For example, a UE (e.g., a UE 115) and a network entity (e.g., a network entity 105), which may be examples of corresponding devices described with reference to FIGS. 1-2, may communicate with each other according to the timeline 300. The transmitting device may be a network entity, and the receiving device may be a UE. However, techniques described herein may be applied to any two devices (e.g., a transmitting device and a receiving device).

In some examples, as described in greater detail with reference to FIG. 2, the network entity may transmit a wireless signal including an OOK signal 305 and an OFDM signal 310. The OFDM signal 310 may include OFDM sequences overlayed over on durations of the OOK signal 305. The OFDM signal 310 may include one of two available candidate OFDM sequences transmitted during each on duration of the OOK signal 305. Each of the two candidate OFDM sequences may indicate a bit value (e.g., 1 or 0). For example, a first OFDM sequence (e.g., during the first on duration of the OOK symbol 0) may indicate a 1, and a second OFDM sequence (e.g., during a last on duration of the OOK symbol 1) may indicate a 0.

The wireless signal may include a message (e.g., a LP-WUS). The bit sequence of the message may be transmitted via the OOK signal 305 (e.g., a bit sequence of 10101101). The bit order of the same message may be reversed, and transmitted via the OFDM signal 310. That is, the bit sequence of the OOK signal 305 may be 10101101, and the bit sequence of the OFDM signal 310 may be 10110101 (e.g., the reverse of the bit sequence of the OOK signal 305). The UE may fully receive the message (e.g., the LP-WUS information) in less time (e.g., in half the time) by receiving a first portion (e.g., half) of the message via the OOK signal 305 (e.g., the bit sequence 1010 during the first four OOK symbols) and by receiving a second portion (e.g., half) of the message via the OFDM signal 310 (e.g., the bit sequence 1011). The UE may then decode the message by decoding the first and second portions of the message and combining the decoded first and second portions (e.g., including reversing the order of the bits received via the OFDM signal 310). The combination of the first half and the second half of the message may include the full bit sequence (e.g., 10101101). However, by receiving half of the message via the OOK signal 305 and half of the message via the OFDM signal 310, the UE may successfully receive the full message in less time (e.g., in four OOK symbols or two OFDM symbols instead of eight OOK symbols or two OFDM symbols). For instance, the UE may receive a LP-WUS in half of the LP-WUS duration if the bit order for the OFDM signal 310 is reversed from the bit order of the OOK signal 305. In some examples, the bit order may be completely reversed (e.g., the final bit of the OOK signal 305 is the first bit of the OFDM signal 310, the second-to-last bit of the OOK signal 305 is the second bit of the OFDM signal 310, etc.). In some examples (e.g., as described in greater detail with reference to FIG. 4), the bit sequence for an OOK signal 405 may first be segmented, and then a set of segments of the bit sequence may be reversed.

FIG. 4 shows an example of a timeline 400 that supports bit ordering for wireless signaling using multiple types of waveforms in accordance with one or more aspects of the present disclosure. The timeline 400 may implement, or be implemented by, aspects of the wireless communications system 100, the timeline 200, or the timeline 300. For example, a UE (e.g., a UE 115) and a network entity (e.g., a network entity 105), which may be examples of corresponding devices described with reference to FIGS. 1-3, may communicate with each other according to the timeline 400. The transmitting device may be a network entity, and the receiving device may be a UE. However, techniques described herein may be applied to any two devices (e.g., a transmitting device and a receiving device).

In some examples, as described in greater detail with reference to FIGS. 2 and 3, the network entity may transmit a wireless signal including an OOK signal 405 and an OFDM signal 410. The OFDM signal 410 may include OFDM sequences 420 overlayed over on durations of the OOK signal 405. The OFDM signal 410 may include one of multiple (e.g., 4) available candidate OFDM sequences transmitted during each on duration of the OOK signal 405. Each of the candidate OFDM sequences may indicate a set of bit values (e.g., for four candidate OFDM sequences, each candidate OFDM sequence may indicate a pair of bits). For example, a first OFDM sequence 420-a may indicate 01, a second OFDM sequence 420-b may indicate 11, a third OFDM sequence 420-c may indicate 10, and a fourth OFDM sequence (e.g., not shown) may indicate 00.

The overlaid OFDM sequences 420 may carry bits of the OOK signal 405 in reversed order. The bits carried by the OOK symbols (e.g., via the OOK signal 405) may be first grouped into segments 415. A quantity of bits in each segment 415 may equal to a quantity of bits carried by each overlaid OFDM sequence 420. For instance, if each OFDM sequence 420 conveys two bits, then each segment 415 may include two bits. Similarly, if each candidate OFDM sequence 420 is capable of conveying four bits (e.g., for sixteen candidate OFDM sequences), then the segments 415 may include four bits. The ordering of the segments 415 may then be reversed in time (e.g., such that the final segment 415-d becomes the first segment). Each segment may then be mapped to an overlaid OFDM sequence 420 and transmitted sequentially. For instance, the bit sequence of the OOK signal 405 may be 10101101. The bits may be segmented into segments 415 (e.g., each segment 415 including two bits based on four candidate OFDM sequences 420, each conveying two bits). Each of the segments 415 may be reversed in order then mapped to the overlaid OFDM sequences 420. In such examples, the segment 415-d may be mapped to the sequence 420-a, the segment 415-c may be mapped to the sequence 420-b, the segment 415-b may be mapped to the sequence 420-c, and the segment 415-a may be mapped to the sequence 420-c. Thus, the bit sequence of the OFDM signal 410 (e.g., as conveyed by the OFDM sequence 420-a, the OFDM sequence 420-b, the OFDM sequence 420-c, and again the OFDM sequence 420-c) may be 01111010 (e.g., the reverse of the segmented bit sequence 10101101).

Upon receipt of the wireless signal (e.g., including both the OOK signal 405 and the OFDM signal 410), the receiving device (e.g., the UE) may receive the full bit sequence of the OFDM signal 410 (e.g., during the OOK symbol 0, the OOK symbol 1, the OOK symbol 2, and the OOK symbol 3), and may complete reception and decoding of the full wireless message early (e.g., without having to monitor and receive during the OOK symbol 4, the OOK symbol 5, the OOK symbol 6, and the OOK symbol 7). Thus, having received the full message sooner in time, the UE may go back to sleep or enter a low power mode for a remainder of the duration of the OOK signal 405 (e.g., or additional resources may be reassigned or utilized for other wireless signaling).

In some examples, a first UE may not support OFDM signaling via the OOK symbols, in which case the UE may monitor for the OOK signal (e.g., across all eight OOK symbols). A second UE that does support OFDM signaling via the OOK symbols may receive the full wireless message earlier in time and may perform additional power savings based thereon. Thus, without additional complexity at the transmitting device, various receiving devices with varying capabilities may successfully receive the wireless signaling (e.g., and devices with higher capabilities may be able to perform the additional power savings described herein). In some examples, the OOK signal 405 may be utilized as a backup or default for a UE that does have capability to receive the OFDM signaling overlaid on the OOK symbols. For instance, if the UE fails to receive the OFDM signal 410 (e.g., during one or more OOK symbols), then the UE may fall back on the OOK signal 405 (e.g., to jointly decode the full message and identity missed content from the OFDM signal 410, or instead of decoding the OFDM signal 410). Thus, the OOK signal 405 may increase the robustness and reliability of the wireless message, while the OFDM signal 410 may (e.g., if successfully received) provide for faster decoding and more efficient use of available power and resources for the UE.

FIG. 5 shows an example of a timeline 500 that supports bit ordering for wireless signaling using multiple types of waveforms in accordance with one or more aspects of the present disclosure. The timeline 500 may implement, or be implemented by, aspects of the wireless communications system 100, the timeline 200, the timeline 300, or the timeline 400. For example, a UE (e.g., a UE 115) and a network entity (e.g., a network entity 105), which may be examples of corresponding devices described with reference to FIGS. 1-4, may communicate with each other according to the timeline 500. The transmitting device may be a network entity, and the receiving device may be a UE. However, techniques described herein may be applied to any two devices (e.g., a transmitting device and a receiving device).

In some examples, as described in greater detail with reference to FIGS. 2-4, the network entity may transmit a wireless signal including an OOK signal 505 and an OFDM signal 510. The OFDM signal 510 may include OFDM sequences 515 overlayed over on durations of the OOK signal 505. The OFDM signal 510 may include one of multiple (e.g., 4) candidate OFDM sequences transmitted during each on duration of the OOK signal 505. Each of the candidate OFDM sequences may indicate a set of bit values (e.g., for four candidate OFDM waveforms, each candidate OFDM waveform may indicate a pair of bits). For example, a first OFDM sequence 515-a may indicate 10, a second OFDM sequence 515-b may indicate 11, a third OFDM sequence 515-c may indicate 01, and a fourth OFDM sequence (e.g., not shown) may indicate 00.

The overlaid OFDM sequences 515 may carry bits of the OOK signal 505 in reversed order. The bits carried by the OOK symbols (e.g., via the OOK signal 505) may be fully reversed in time. In some examples, after being reversed in time, the bits may be segmented. Each segment may then be mapped to an overlaid sequence and then transmitted sequentially. For example, the bit sequence of the OOK signal 505 may be 10101101. This bit sequence may be reversed, such that the final bit (e.g., 1) becomes the first bit of the reversed sequence, and the second-to-last bit (e.g., 0) becomes the second bit of the reversed sequence, etc. In some examples, the reversed sequence may be segmented and mapped to the OFDM sequences 515. For instance, a first segment of the reversed bit sequence (e.g., 10) may be mapped to the OFDM sequence 515-a, a second segment of the reversed bit sequence (e.g., 11) may be mapped to the OFDM sequence 515-b, a third segment of the reversed bit sequence (e.g., 01) may be mapped to the OFDM sequence 515-c, and a fourth segment of the reversed bit sequence (e.g., 01) may be mapped to the OFDM sequence 515-c. Thus, the OOK signal 505 may carry the initial bit sequence (e.g., 10101101) via the OOK modulation (e.g., across a full duration of the message, such as OOK symbols 0-7). The OFDM signal 510 may be transmitted via on durations of the OOK symbol, and may carry the reversed bit sequence (e.g., 10110101) during less time than the OOK signal 505 (e.g., via the OOK symbols 0-3). In some examples, the wireless message (e.g., an LP-WUS) may be detected in 1.5 or two OFDM symbols (e.g., with the bit order reversal described herein with reference to FIGS. 4 and 5), instead of the full duration of the OOK signal 505 (e.g., eight OOK symbols).

Upon receipt of the wireless signal (e.g., including both the OOK signal 505 and the OFDM signal 510), the receiving device (e.g., the UE) may receive the full bit sequence of the OFDM signal 510 (e.g., during the OOK symbols 0-3), and may complete reception and decoding of the full wireless message early (e.g., without having to monitor and receive during the OOK symbols 4-7). Thus, having received the full message sooner in time, the UE may go back to sleep or enter a low power mode for a remainder of the duration of the OOK signal 505 (e.g., or additional resources may be reassigned or utilized for other wireless signaling).

In some examples, a first UE may not support OFDM signaling via the OOK symbols, in which case the UE may monitor for a receive the OOK signal (e.g., across all eight OOK symbols). A second UE that does support OFDM signaling via the OOK symbols may receive the full wireless message earlier in time and may perform additional power savings based thereon. Thus, without additional complexity at the transmitting device, various receiving devices with varying capabilities may successfully receive the wireless signaling (e.g., and devices with higher capabilities may be able to perform the additional power savings described herein). In some examples, the OOK signal 505 may be utilized as a backup or default for a UE that does have capability to receive the OFDM signaling overlaid on the OOK symbols. For instance, if the UE fails to receive the OFDM signal 510 (e.g., during one or more OOK symbols), then the UE may fall back on the OOK signal 505 (e.g., to jointly decode the full message and identity missed content from the OFDM signal 510, or instead of decoding the OFDM signal 510). Thus, the OOK signal 505 may increase the robustness and reliability of the wireless message, while the OFDM signal 510 may (e.g., if successfully received) provide for faster decoding and more efficient use of available power and resources for the UE.

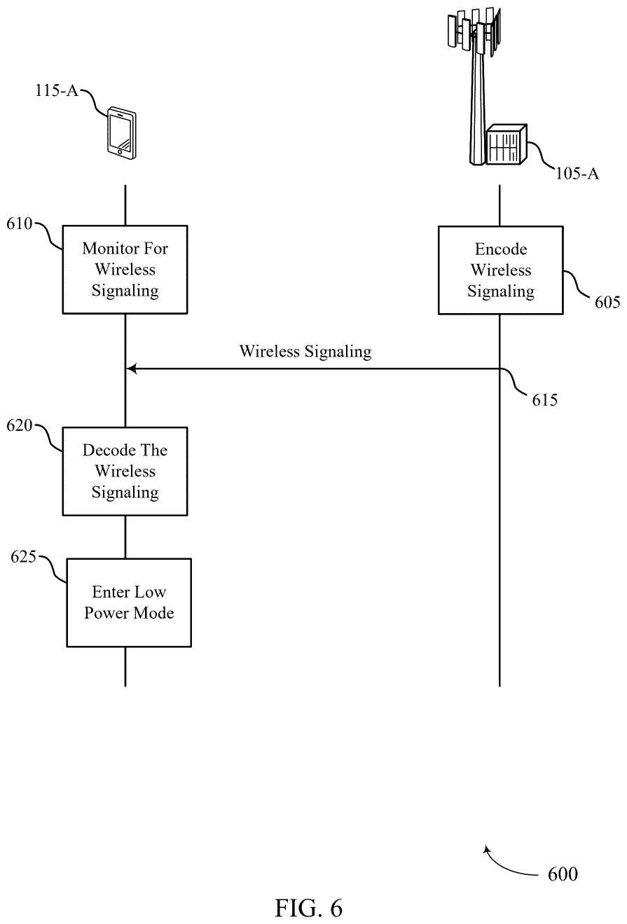

FIG. 6 shows an example of a process flow 600 that supports bit ordering for wireless signaling using multiple types of waveforms in accordance with one or more aspects of the present disclosure. The process flow 600 may implement, or be implemented by, aspects of the wireless communications system 100, the timeline 200, the timeline 300, the timeline 400, or the timeline 500. For example, a UE (e.g., the UE 115-a) and a network entity (e.g., the network entity 105-a) may be examples of corresponding devices described with reference to FIGS. 1-5. The transmitting device may be a network entity 105-a, and the receiving device may be a UE 115-a. However, techniques described herein may be applied to any two devices (e.g., a transmitting device and a receiving device).

As described herein, the network entity 105-a may transmit wireless signaling (e.g., at 615). The UE 115-a may receive the wireless signaling including a first wireless signal and a second wireless signal, each carrying the same information (e.g., the same bits). The first wireless signal may be modulated by a first modulation scheme (e.g., an OOK modulation scheme) and the second wireless signal may be modulated by a second modulation scheme (e.g., an OFDM modulation scheme). The first and second wireless signals may be transmitted via different bandwidths, using different scrambling sequences, different encoding procedures, different modulations, or any combination thereof. In some examples, the bits of the same information carried by the two wireless signals may be ordered differently (e.g., one bit sequence may be the reverse order of the other bit sequence).

In some examples, at 605, the network entity 105-a may encode the wireless signaling for transmission (e.g., to the UE 115-a). The network entity 105-a may encode a first sequence of bits of a first wireless signal according to a first coding scheme (e.g., an OOK signal) and a second sequence of bits of a second wireless signal according to a second wireless signal (e.g., an OFDM signal). The network entity 105-a may overlay the OFDM signal (e.g., one or more OFDM sequences) over on durations of the OOK signal.

At 610, the UE 115-a may monitor for the wireless signaling during multiple OOK symbols.

At 615, the UE 115-a may receive the wireless signaling based on the monitoring. The wireless signaling may include an OOK signal including one or more on durations and one or more off durations within the OOK symbols and an OFDM signal located within one or more on durations of the OOK signal. The OOK signal may carry a first sequence of bits and the OFDM signal may carry a second sequence of bits, where the second sequence of bits is a reordering of the first set of bits. A subset of the second set of bits may occur in a first OOK symbol of the OOK symbols and may be a subset of the first set of bits occurring in a second OOK symbol that occurs after the first OOK symbol. That is, a first OOK symbol may include some of the bits of a wireless message transmitted via the OOK signal, and additional bits transmitted by the OOK signal in a subsequent OOK symbol may also be transmitted in the first OOK symbol via the OFDM signal.

In some examples (e.g., as described in greater detail with reference to FIG. 3), the second sequence of bits may be the first sequence of bits in a reverse order such that the first sequence of bits is a set of bits in ascending order, and the second sequence of bits is the first sequence of bits in descending order.

In some examples (e.g., as described in greater detail with reference to FIG. 4), the first sequence of bits may be segmented, and the second sequence of bits may be the segments of the first sequence of bits in reverse order. In some examples, as described in greater detail with reference to FIGS. 4-5, a quantity of bits in the subset of the second sequence of bits occurring in the first OOK symbol may be greater than a quantity of bits in the subset of the first sequence of bits occurring in the first OOK symbol (e.g., an OFDM sequence in an on duration of an OOK symbol may carry more bits than the OOK signal in the same OOK symbol). In such examples, the OFDM signal may carry more information in less time, resulting in an earlier reception of the same information via the OFDM signal. In some examples, as described in greater detail with reference to FIG. 3, a quantity of bits in the subset of the second sequence of bits occurring in the first OOK symbol is equal to a quantity of bits in the subset of the first sequence of bits occurring in the first OOK symbol. In such examples, the UE may decode a portion of the OOK signal and a portion of the OFDM signal and may combine the received portions of the two signals to receive the entire message in less time.

In some examples, based on receiving the full message (e.g., via the OFDM signal prior to complete reception of the OOK signal, or by receiving a portion of the OFDM signal and a portion of the OOK signal), the UE 115-a may ignore at least a portion of the OOK signal during a remainder of the OOK symbols occurring after the first portion of the OOK symbols. The UE 115-a may enter a power saving mode (e.g., may go back to sleep) during the second portion of the OOK symbols (e.g., during a portion of symbol 1, or during symbol 2 and symbol 3 as illustrated with reference to FIGS. 2-4). For instance, the UE 115-a may enter a low power sleep mode, and at 610 may monitor for a LP-WUS (e.g., via LP-WUS resources, or according to a WUS configuration). After receiving the full LP-WUS (e.g., within a time period that is less than the duration of the LP-WUS according to techniques described herein), the UE 115-a may re-enter the low power sleep mode (e.g., at 625).

At 620, the UE 115-a may decode the wireless signaling including at least a portion of the first sequence of bits (e.g., if the UE 115-a does not have the capability to receive the message earlier via the OFDM signal or if the OFDM signal is not successfully received), at least a portion of the second sequence of bits (e.g., receiving the full OFDM signal early as described in greater detail with reference to FIGS. 4-5), or both (e.g., by combining a first portion of the OOK signal and the first portion of the OFDM signal, as described in greater detail with reference to FIG. 3).

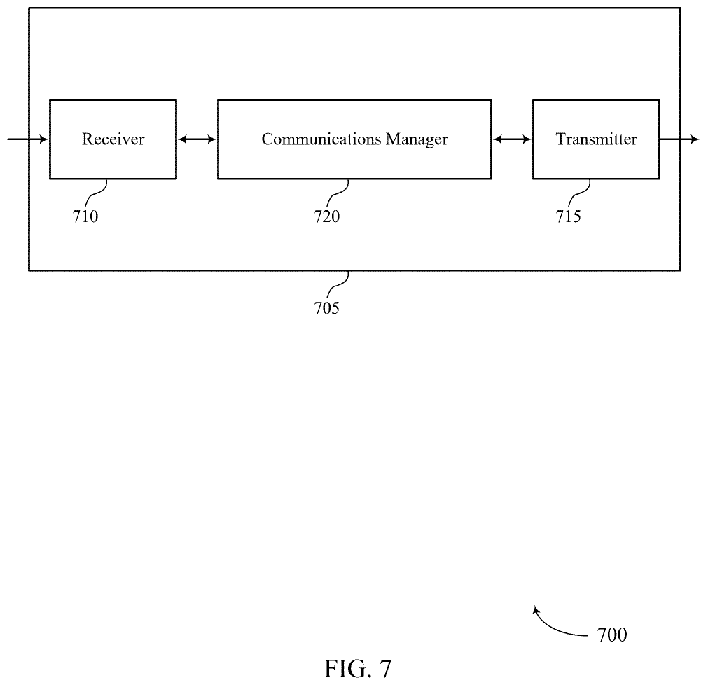

FIG. 7 shows a block diagram 700 of a device 705 that supports bit ordering for wireless signaling using multiple types of waveforms in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to bit ordering for wireless signaling using multiple types of waveforms). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to bit ordering for wireless signaling using multiple types of waveforms). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of bit ordering for wireless signaling using multiple types of waveforms as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for monitoring for wireless signaling during a set of multiple OOK symbols. The communications manager 720 is capable of, configured to, or operable to support a means for receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The communications manager 720 is capable of, configured to, or operable to support a means for decoding a wireless message including at least a portion of the first set of multiple bits, at least a portion of the second set of multiple bits, or both, based on receiving the wireless signaling including the OOK signal and the OFDM signal.

Additionally, or alternatively, the communications manager 720 may support wireless communications in accordance with examples as disclosed herein. For example, the communications manager 720 is capable of, configured to, or operable to support a means for receiving a first wireless signal and a second wireless signal during a same time duration, where the first signal and the second signal each carry the same information. The communications manager 720 is capable of, configured to, or operable to support a means for decoding at least a portion of the first wireless signal, or at least a portion of the second wireless signal, or both.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reception of overlaid signals resulting in reduced power consumption, more efficient use of available system resources, and improved user experience.

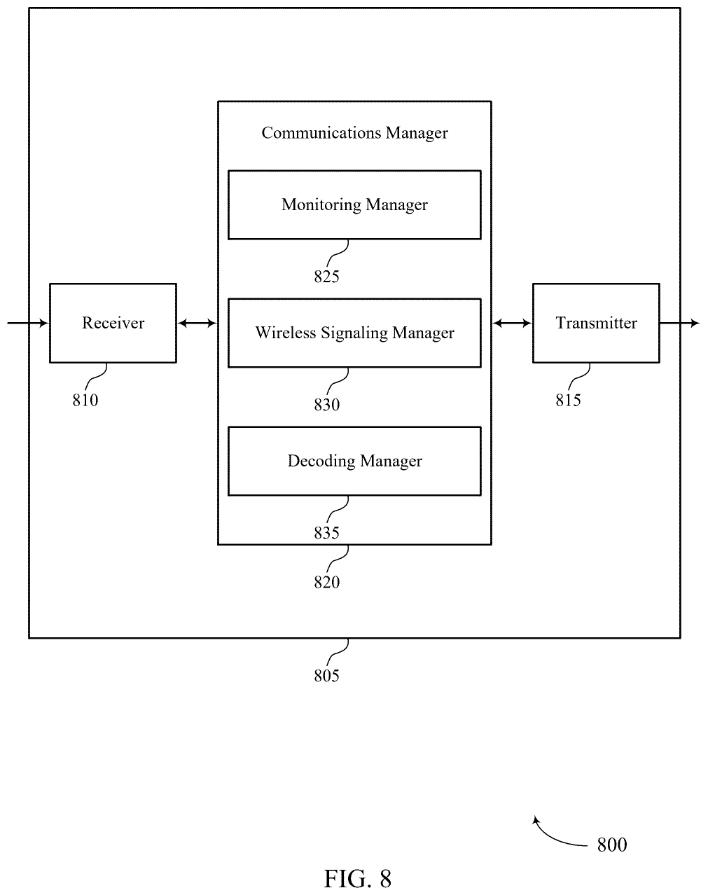

FIG. 8 shows a block diagram 800 of a device 805 that supports bit ordering for wireless signaling using multiple types of waveforms in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to bit ordering for wireless signaling using multiple types of waveforms). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to bit ordering for wireless signaling using multiple types of waveforms). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of bit ordering for wireless signaling using multiple types of waveforms as described herein. For example, the communications manager 820 may include a monitoring manager 825, a wireless signaling manager 830, a decoding manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The monitoring manager 825 is capable of, configured to, or operable to support a means for monitoring for wireless signaling during a set of multiple OOK symbols. The wireless signaling manager 830 is capable of, configured to, or operable to support a means for receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The decoding manager 835 is capable of, configured to, or operable to support a means for decoding a wireless message including at least a portion of the first set of multiple bits, at least a portion of the second set of multiple bits, or both, based on receiving the wireless signaling including the OOK signal and the OFDM signal.

Additionally, or alternatively, the communications manager 820 may support wireless communications in accordance with examples as disclosed herein. The wireless signaling manager 830 is capable of, configured to, or operable to support a means for receiving a first wireless signal and a second wireless signal during a same time duration, where the first signal and the second signal each carry the same information. The decoding manager 835 is capable of, configured to, or operable to support a means for decoding at least a portion of the first wireless signal, or at least a portion of the second wireless signal, or both.

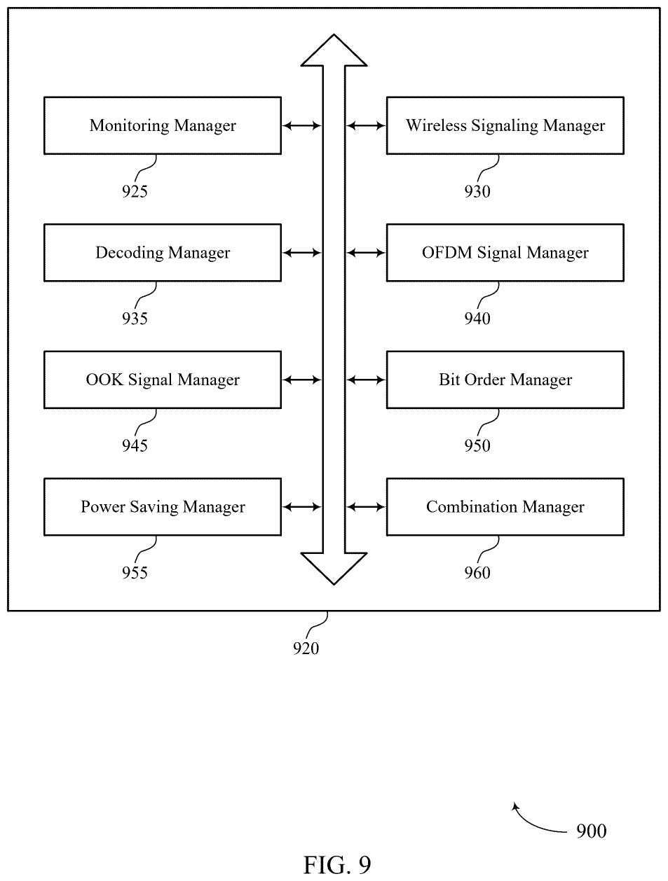

FIG. 9 shows a block diagram 900 of a communications manager 920 that supports bit ordering for wireless signaling using multiple types of waveforms in accordance with one or more aspects of the present disclosure. The communications manager 920 may be an example of aspects of a communications manager 720, a communications manager 820, or both, as described herein. The communications manager 920, or various components thereof, may be an example of means for performing various aspects of bit ordering for wireless signaling using multiple types of waveforms as described herein. For example, the communications manager 920 may include a monitoring manager 925, a wireless signaling manager 930, a decoding manager 935, an OFDM signal manager 940, a OOK signal manager 945, a bit order manager 950, a power saving manager 955, a combination manager 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The monitoring manager 925 is capable of, configured to, or operable to support a means for monitoring for wireless signaling during a set of multiple OOK symbols. The wireless signaling manager 930 is capable of, configured to, or operable to support a means for receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The decoding manager 935 is capable of, configured to, or operable to support a means for decoding a wireless message including at least a portion of the first set of multiple bits, at least a portion of the second set of multiple bits, or both, based on receiving the wireless signaling including the OOK signal and the OFDM signal.

In some examples, the second set of multiple bits includes the first set of multiple bits in reverse order according to the reordering such that the first set of multiple bits includes an ascending order of a set of bits and the second set of multiple bits includes a descending order of the set of bits.

In some examples, the first set of multiple bits includes a first set of segments and the second set of multiple bits includes a second set of segments. In some examples, the second set of segments includes the first set of segments in reverse order according to the reordering.

In some examples, a quantity of bits in the subset of the second set of multiple bits occurring in the first OOK symbol is greater than a quantity of bits in the subset of the first set of multiple bits occurring in the first OOK symbol.

In some examples, a quantity of bits in the subset of the second set of multiple bits occurring in the first OOK symbol is equal to a quantity of bits in the subset of the first set of multiple bits occurring in the first OOK symbol.

In some examples, to support receiving the wireless signaling, the OFDM signal manager 940 is capable of, configured to, or operable to support a means for receiving the OFDM signal during a first portion of the set of multiple OOK symbols, where the second set of multiple bits includes the reordering of the first set of multiple bits occurs within the first portion of the set of multiple OOK symbols.

In some examples, the power saving manager 955 is capable of, configured to, or operable to support a means for ignoring at least a portion of the OOK signal during at least a second portion of the set of multiple OOK symbols occurring after the first portion of the set of multiple OOK symbols.

In some examples, the power saving manager 955 is capable of, configured to, or operable to support a means for entering a power saving mode during at least a second portion of the set of multiple OOK symbols occurring after the first portion of the set of multiple OOK symbols.

In some examples, the OFDM signal located within the one or more on durations of the OOK signal includes one of a set of multiple candidate OFDM waveforms, each candidate OFDM waveform corresponding to respective portion of a bitstream.

In some examples, to support receiving the wireless signaling, the OOK signal manager 945 is capable of, configured to, or operable to support a means for receiving a first portion of the OOK signal during a first portion of the set of multiple OOK symbols, the first portion of the OOK signal including a first portion of the first set of multiple bits. In some examples, to support receiving the wireless signaling, the OFDM signal manager 940 is capable of, configured to, or operable to support a means for receiving a first portion of the OFDM signal during the first portion of the set of multiple OOK symbols, the second portion of the OFDM signal including a first portion of the second set of multiple bits.

In some examples, the combination manager 960 is capable of, configured to, or operable to support a means for combining the first portion of the first set of multiple bits with the first portion of the second set of multiple bits, where the first portion of the first set of multiple bits includes a first portion of the wireless message and the first portion of the second set of multiple bits includes a second portion of the wireless message according to the reordering, and where decoding the wireless message is based on the combining.

In some examples, the OOK signal manager 945 is capable of, configured to, or operable to support a means for ignoring a second portion of the OOK signal and a second portion of the OFDM signal during a second portion of the set of multiple OOK symbols occurring after the first portion of the set of multiple OOK symbols based on the receiving.

In some examples, the power saving manager 955 is capable of, configured to, or operable to support a means for entering a power saving mode during a second portion of the set of multiple OOK symbols occurring after the first portion of the set of multiple OOK symbols.

In some examples, the bit order manager 950 is capable of, configured to, or operable to support a means for receiving control signaling indicating the reordering, where decoding the wireless message is based on the control signaling indicating the reordering.

In some examples, the power saving manager 955 is capable of, configured to, or operable to support a means for entering a low power sleep mode according to a power saving configuration. In some examples, the monitoring manager 925 is capable of, configured to, or operable to support a means for monitoring for the wireless signaling including a low-power wakeup signal via a low-power wakeup radio according to a low power monitoring mode, where receiving the wireless signaling is based on the monitoring and the decoding occurs within a first portion of the set of multiple OOK symbols based on the reordering. In some examples, the power saving manager 955 is capable of, configured to, or operable to support a means for re-entering the low power sleep mode during a second portion of the set of multiple OOK symbols occurring after the first portion of the set of multiple OOK symbols.

Additionally, or alternatively, the communications manager 920 may support wireless communications in accordance with examples as disclosed herein. In some examples, the wireless signaling manager 930 is capable of, configured to, or operable to support a means for receiving a first wireless signal and a second wireless signal during a same time duration, where the first signal and the second signal each carry the same information. In some examples, the decoding manager 935 is capable of, configured to, or operable to support a means for decoding at least a portion of the first wireless signal, or at least a portion of the second wireless signal, or both.

In some examples, the first wireless signal is received via first bandwidth, is scrambled according to a first scrambling sequence, is encoded according to a first encoding procedure, is modulated by a first modulation scheme, or any combination thereof. In some examples, the second wireless signal is received via a second bandwidth that is different than the first bandwidth, is scrambled according to a second scrambling sequence that is different than the first scrambling sequence, is encoded according to a second encoding procedure that is different than the first encoding procedure, is modulated by a second modulation scheme that is different than the first modulation scheme, or any combination thereof.

In some examples, the first modulation scheme includes an on-off key (OFF) modulation scheme, and the second modulation scheme includes an orthogonal frequency division modulation (OFDM) modulation scheme.

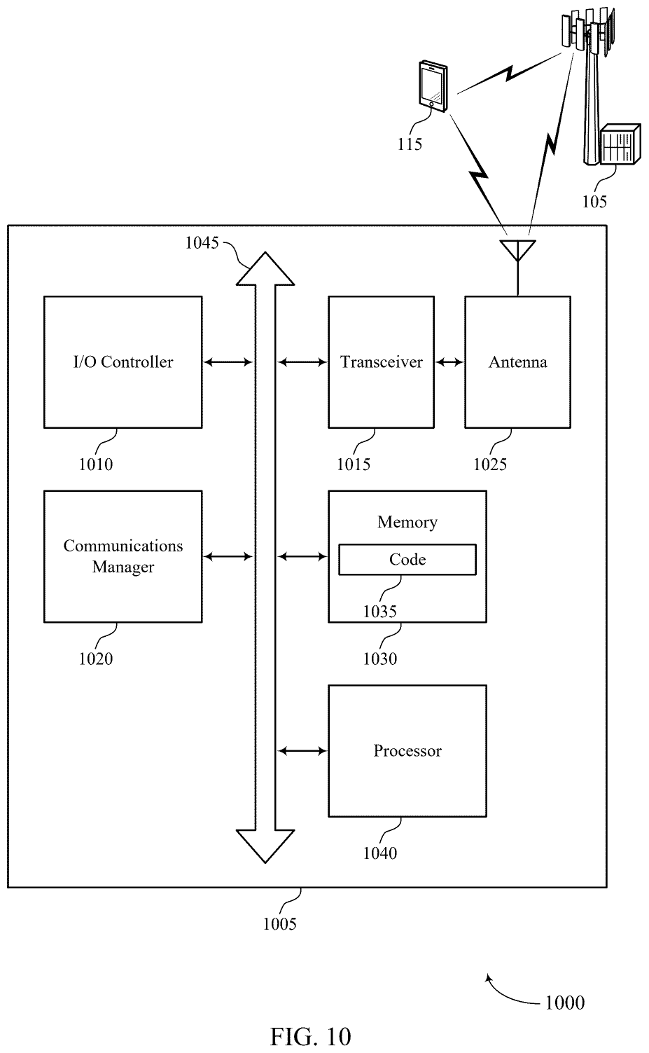

FIG. 10 shows a diagram of a system 1000 including a device 1005 that supports bit ordering for wireless signaling using multiple types of waveforms in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting bit ordering for wireless signaling using multiple types of waveforms). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for monitoring for wireless signaling during a set of multiple OOK symbols. The communications manager 1020 is capable of, configured to, or operable to support a means for receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The communications manager 1020 is capable of, configured to, or operable to support a means for decoding a wireless message including at least a portion of the first set of multiple bits, at least a portion of the second set of multiple bits, or both, based on receiving the wireless signaling including the OOK signal and the OFDM signal.

Additionally, or alternatively, the communications manager 1020 may support wireless communications in accordance with examples as disclosed herein. For example, the communications manager 1020 is capable of, configured to, or operable to support a means for receiving a first wireless signal and a second wireless signal during a same time duration, where the first signal and the second signal each carry the same information. The communications manager 1020 is capable of, configured to, or operable to support a means for decoding at least a portion of the first wireless signal, or at least a portion of the second wireless signal, or both.

By including or configuring the communications manager 1020 in accordance with examples as described herein, the device 1005 may support techniques for reception of overlaid signals resulting in reduced power consumption, more efficient use of available system resources, improved communication reliability, improved coordination between devices, longer battery life, improved throughput, improved utilization of processing capability, and improved user experience.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of bit ordering for wireless signaling using multiple types of waveforms as described herein, or the at least one processor 1040 and the at least one memory 1030 may be otherwise configured to, individually or collectively, perform or support such operations.

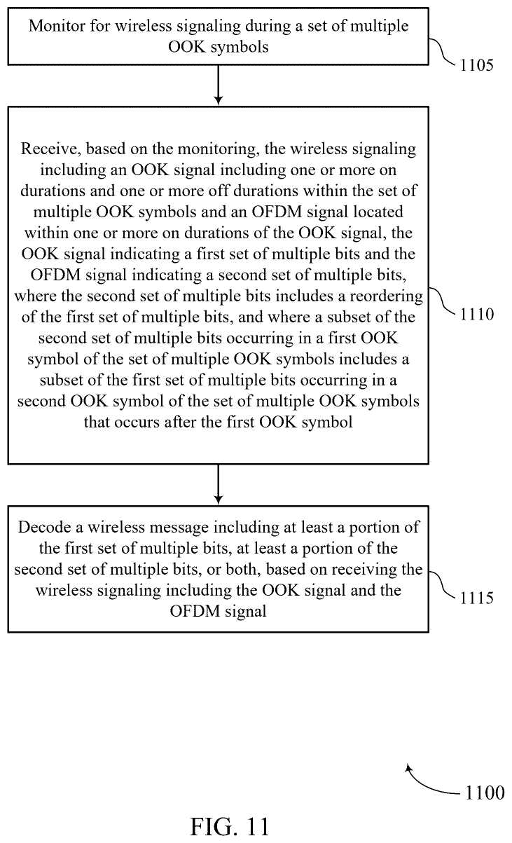

FIG. 11 shows a flowchart illustrating a method 1100 that supports bit ordering for wireless signaling using multiple types of waveforms in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include monitoring for wireless signaling during a set of multiple OOK symbols. The operations of 1105 may be performed in accordance with examples as disclosed herein. In some examples, aspects of the operations of 1105 may be performed by a monitoring manager 925 as described with reference to FIG. 9.

At 1110, the method may include receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The operations of 1110 may be performed in accordance with examples as disclosed herein. In some examples, aspects of the operations of 1110 may be performed by a wireless signaling manager 930 as described with reference to FIG. 9.

At 1115, the method may include decoding a wireless message including at least a portion of the first set of multiple bits, at least a portion of the second set of multiple bits, or both, based on receiving the wireless signaling including the OOK signal and the OFDM signal. The operations of 1115 may be performed in accordance with examples as disclosed herein. In some examples, aspects of the operations of 1115 may be performed by a decoding manager 935 as described with reference to FIG. 9.

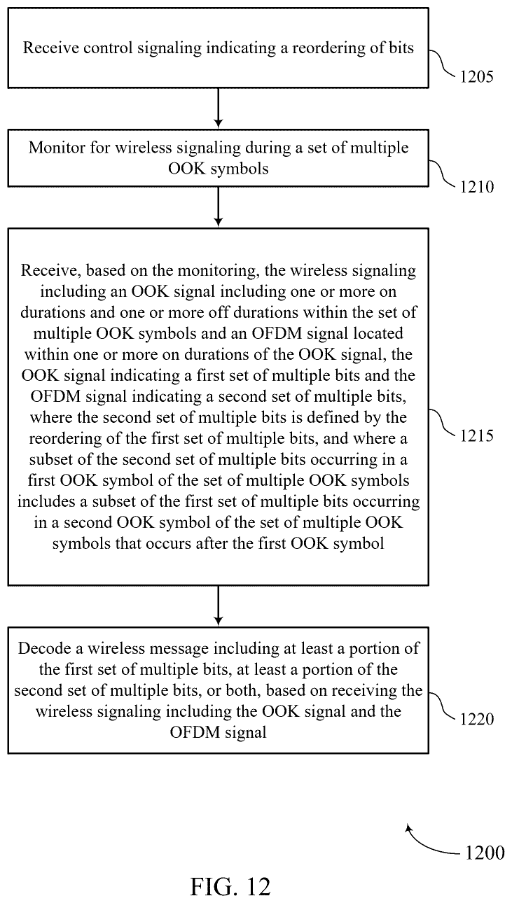

FIG. 12 shows a flowchart illustrating a method 1200 that supports bit ordering for wireless signaling using multiple types of waveforms in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving control signaling indicating a reordering of bits, where decoding the wireless message is based on the control signaling indicating the reordering. The operations of 1205 may be performed in accordance with examples as disclosed herein. In some examples, aspects of the operations of 1205 may be performed by a bit order manager 950 as described with reference to FIG. 9.

At 1210, the method may include monitoring for wireless signaling during a set of multiple OOKO symbols. The operations of 1210 may be performed in accordance with examples as disclosed herein. In some examples, aspects of the operations of 1210 may be performed by a monitoring manager 925 as described with reference to FIG. 9.

At 1215, the method may include receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits is defined by the reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The operations of 1215 may be performed in accordance with examples as disclosed herein. In some examples, aspects of the operations of 1215 may be performed by a wireless signaling manager 930 as described with reference to FIG. 9.

At 1220, the method may include decoding a wireless message including at least a portion of the first set of multiple bits, at least a portion of the second set of multiple bits, or both, based on receiving the wireless signaling including the OOK signal and the OFDM signal. The operations of 1220 may be performed in accordance with examples as disclosed herein. In some examples, aspects of the operations of 1220 may be performed by a decoding manager 935 as described with reference to FIG. 9.

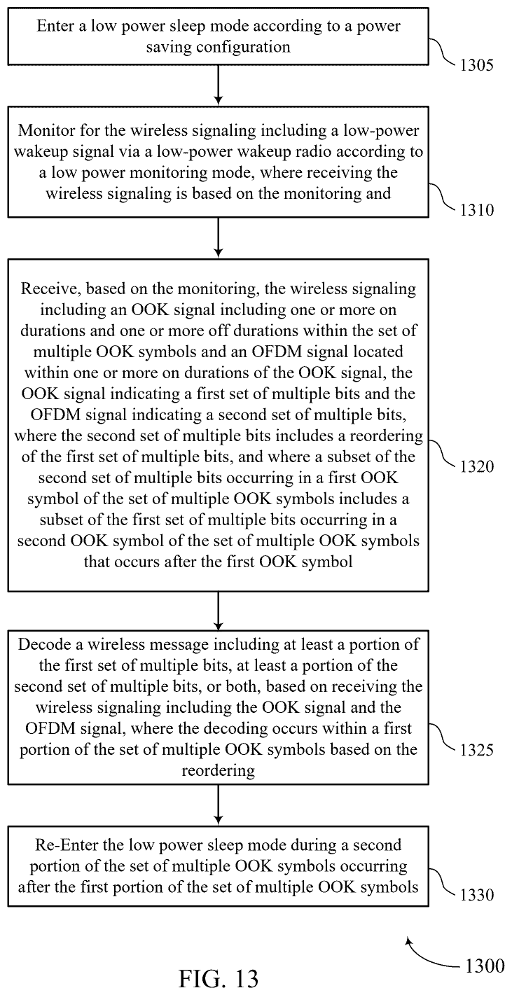

FIG. 13 shows a flowchart illustrating a method 1300 that supports bit ordering for wireless signaling using multiple types of waveforms in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include entering a low power sleep mode according to a power saving configuration. The operations of 1305 may be performed in accordance with examples as disclosed herein. In some examples, aspects of the operations of 1305 may be performed by a power saving manager 955 as described with reference to FIG. 9.

At 1310, the method may include monitoring for the wireless signaling including a low-power wakeup signal via a low-power wakeup radio according to a low power monitoring mode, where receiving the wireless signaling is based on the monitoring and the decoding occurs within a first portion of the set of multiple OOK symbols based on the reordering. The operations of 1310 may be performed in accordance with examples as disclosed herein. In some examples, aspects of the operations of 1310 may be performed by a monitoring manager 925 as described with reference to FIG. 9.

At 1320, the method may include receiving, based on the monitoring, the wireless signaling including an OOK signal including one or more on durations and one or more off durations within the set of multiple OOK symbols and an OFDM signal located within one or more on durations of the OOK signal, the OOK signal indicating a first set of multiple bits and the OFDM signal indicating a second set of multiple bits, where the second set of multiple bits includes a reordering of the first set of multiple bits, and where a subset of the second set of multiple bits occurring in a first OOK symbol of the set of multiple OOK symbols includes a subset of the first set of multiple bits occurring in a second OOK symbol of the set of multiple OOK symbols that occurs after the first OOK symbol. The operations of 1320 may be performed in accordance with examples as disclosed herein. In some examples, aspects of the operations of 1320 may be performed by a wireless signaling manager 930 as described with reference to FIG. 9.

At 1325, the method may include decoding a wireless message including at least a portion of the first set of multiple bits, at least a portion of the second set of multiple bits, or both, based on receiving the wireless signaling including the OOK signal and the OFDM signal, where the decoding occurs within a first portion of the set of multiple OOK symbols based on the reordering. The operations of 1325 may be performed in accordance with examples as disclosed herein. In some examples, aspects of the operations of 1325 may be performed by a decoding manager 935 as described with reference to FIG. 9.

At 1330, the method may include re-entering the low power sleep mode during a second portion of the set of multiple OOK symbols occurring after the first portion of the set of multiple OOK symbols. The operations of 1330 may be performed in accordance with examples as disclosed herein. In some examples, aspects of the operations of 1330 may be performed by a power saving manager 955 as described with reference to FIG. 9.

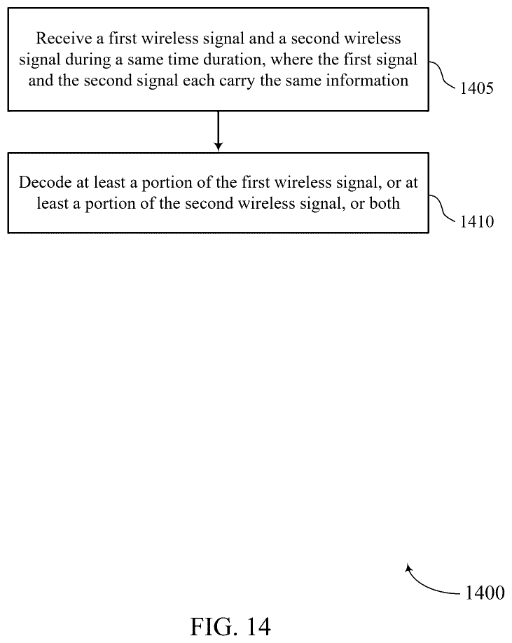

FIG. 14 shows a flowchart illustrating a method 1400 that supports bit ordering for wireless signaling using multiple types of waveforms in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving a first wireless signal and a second wireless signal during a same time duration, where the first signal and the second signal each carry the same information. The operations of 1405 may be performed in accordance with examples as disclosed herein. In some examples, aspects of the operations of 1405 may be performed by a wireless signaling manager 930 as described with reference to FIG. 9.

At 1410, the method may include decoding at least a portion of the first wireless signal, or at least a portion of the second wireless signal, or both. The operations of 1410 may be performed in accordance with examples as disclosed herein. In some examples, aspects of the operations of 1410 may be performed by a decoding manager 935 as described with reference to FIG. 9.

The following provides an overview of aspects of the present disclosure:

Aspect 1: A method for wireless communications at a UE, comprising: monitoring for wireless signaling during a plurality of OOK symbols; receiving, based at least in part on the monitoring, the wireless signaling comprising an OOK signal comprising one or more on durations and one or more off durations within the plurality of OOK symbols and an OFDM signal located within one or more on durations of the OOK signal, the OOK signal indicating a first plurality of bits and the OFDM signal indicating a second plurality of bits, wherein the second plurality of bits comprises a reordering of the first plurality of bits, and wherein a subset of the second plurality of bits occurring in a first OOK symbol of the plurality of OOK symbols comprises a subset of the first plurality of bits occurring in a second OOK symbol of the plurality of OOK symbols that occurs after the first OOK symbol; and decoding a wireless message comprising at least a portion of the first plurality of bits, at least a portion of the second plurality of bits, or both, based at least in part on receiving the wireless signaling comprising the OOK signal and the OFDM signal.

Aspect 2: The method of aspect 1, wherein the second plurality of bits comprises the first plurality of bits in reverse order according to the reordering such that the first plurality of bits comprises an ascending order of a set of bits and the second plurality of bits comprises a descending order of the set of bits.

Aspect 3: The method of any of aspects 1 through 2, wherein the first plurality of bits comprises a first set of segments and the second plurality of bits comprises a second set of segments, and the second set of segments comprises the first set of segments in reverse order according to the reordering.

Aspect 4: The method of any of aspects 1 through 3, wherein a quantity of bits in the subset of the second plurality of bits occurring in the first OOK symbol is greater than a quantity of bits in the subset of the first plurality of bits occurring in the first OOK symbol.

Aspect 5: The method of any of aspects 1 through 4, wherein a quantity of bits in the subset of the second plurality of bits occurring in the first OOK symbol is equal to a quantity of bits in the subset of the first plurality of bits occurring in the first OOK symbol.

Aspect 6: The method of any of aspects 1 through 5, wherein receiving the wireless signaling comprises: receiving the OFDM signal during a first portion of the plurality of OOK symbols, wherein the second plurality of bits comprises the reordering of the first plurality of bits occurs within the first portion of the plurality of OOK symbols.

Aspect 7: The method of aspect 6, further comprising: ignoring at least a portion of the OOK signal during at least a second portion of the plurality of OOK symbols occurring after the first portion of the plurality of OOK symbols.

Aspect 8: The method of any of aspects 6 through 7, further comprising: entering a power saving mode during at least a second portion of the plurality of OOK symbols occurring after the first portion of the plurality of OOK symbols.

Aspect 9: The method of any of aspects 6 through 8, wherein the OFDM signal located within the one or more on durations of the OOK signal comprises one of a plurality of candidate OFDM waveforms, each candidate OFDM waveform corresponding to respective portion of a bitstream.

Aspect 10: The method of any of aspects 1 through 9, wherein receiving the wireless signaling comprises: receiving a first portion of the OOK signal during a first portion of the plurality of OOK symbols, the first portion of the OOK signal comprising a first portion of the first plurality of bits; and receiving a first portion of the OFDM signal during the first portion of the plurality of OOK symbols, the second portion of the OFDM signal comprising a first portion of the second plurality of bits.

Aspect 11: The method of aspect 10, further comprising: combining the first portion of the first plurality of bits with the first portion of the second plurality of bits, wherein the first portion of the first plurality of bits comprises a first portion of the wireless message and the first portion of the second plurality of bits comprises a second portion of the wireless message according to the reordering, and wherein decoding the wireless message is based at least in part on the combining.

Aspect 12: The method of any of aspects 10 through 11, further comprising: ignoring a second portion of the OOK signal and a second portion of the OFDM signal during a second portion of the plurality of OOK symbols occurring after the first portion of the plurality of OOK symbols based at least in part on the receiving.

Aspect 13: The method of any of aspects 10 through 12, further comprising: entering a power saving mode during a second portion of the plurality of OOK symbols occurring after the first portion of the plurality of OOK symbols.

Aspect 14: The method of any of aspects 1 through 13, further comprising: receiving control signaling indicating the reordering, wherein decoding the wireless message is based at least in part on the control signaling indicating the reordering.

Aspect 15: The method of any of aspects 1 through 14, further comprising: entering a low power sleep mode according to a power saving configuration; monitoring for the wireless signaling comprising a low-power wakeup signal via a low-power wakeup radio according to a low power monitoring mode, wherein receiving the wireless signaling is based at least in part on the monitoring and the decoding occurs within a first portion of the plurality of OOK symbols based at least in part on the reordering; and re-entering the low power sleep mode during a second portion of the plurality of OOK symbols occurring after the first portion of the plurality of OOK symbols.

Aspect 16: A method for wireless communications at a UE, comprising: receiving a first wireless signal and a second wireless signal during a same time duration, wherein the first signal and the second signal each carry the same information; and decoding at least a portion of the first wireless signal, or at least a portion of the second wireless signal, or both.

Aspect 17: The method of aspect 16, wherein the first wireless signal is received via first bandwidth, is scrambled according to a first scrambling sequence, is encoded according to a first encoding procedure, is modulated by a first modulation scheme, or any combination thereof; and the second wireless signal is received via a second bandwidth that is different than the first bandwidth, is scrambled according to a second scrambling sequence that is different than the first scrambling sequence, is encoded according to a second encoding procedure that is different than the first encoding procedure, is modulated by a second modulation scheme that is different than the first modulation scheme, or any combination thereof.

Aspect 18: The method of aspect 17, wherein the first modulation scheme comprises an on-off key (OFF) modulation scheme, and the second modulation scheme comprises an orthogonal frequency division modulation (OFDM) modulation scheme.

Aspect 19: A UE for wireless communications, comprising one or more memories storing processor-executable code, and one or more processors coupled with the one or more memories and individually or collectively operable to execute the code to cause the UE to perform a method of any of aspects 1 through 15.

Aspect 20: A UE for wireless communications, comprising at least one means for performing a method of any of aspects 1 through 15.

Aspect 21: A non-transitory computer-readable medium storing code for wireless communications, the code comprising instructions executable by one or more processors to perform a method of any of aspects 1 through 15.

Aspect 22: A UE for wireless communications, comprising one or more memories storing processor-executable code, and one or more processors coupled with the one or more memories and individually or collectively operable to execute the code to cause the UE to perform a method of any of aspects 16 through 18.

Aspect 23: A UE for wireless communications, comprising at least one means for performing a method of any of aspects 16 through 18.

Aspect 24: A non-transitory computer-readable medium storing code for wireless communications, the code comprising instructions executable by one or more processors to perform a method of any of aspects 16 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
monitor for wireless signaling during a plurality of on-off keying (OOK) symbols;
receive, based at least in part on the monitoring, the wireless signaling comprising an OOK signal comprising one or more on durations and one or more off durations within the plurality of OOK symbols and an orthogonal frequency division multiplexing (OFDM) signal located within one or more on durations of the OOK signal, the OOK signal indicating a first plurality of bits and the OFDM signal indicating a second plurality of bits, wherein the second plurality of bits comprises a reordering of the first plurality of bits, and wherein a subset of the second plurality of bits occurring in a first OOK symbol of the plurality of OOK symbols comprises a subset of the first plurality of bits occurring in a second OOK symbol of the plurality of OOK symbols that occurs after the first OOK symbol; and
decode a wireless message comprising at least a portion of the first plurality of bits, at least a portion of the second plurality of bits, or both, based at least in part on receiving the wireless signaling comprising the OOK signal and the OFDM signal.

2. The UE of claim 1, wherein the second plurality of bits comprises the first plurality of bits in reverse order according to the reordering such that the first plurality of bits comprises an ascending order of a set of bits and the second plurality of bits comprises a descending order of the set of bits.

3. The UE of claim 1, wherein:
the first plurality of bits comprises a first set of segments and the second plurality of bits comprises a second set of segments, and
the second set of segments comprises the first set of segments in reverse order according to the reordering.

4. The UE of claim 1, wherein a quantity of bits in the subset of the second plurality of bits occurring in the first OOK symbol is greater than a quantity of bits in the subset of the first plurality of bits occurring in the first OOK symbol.

5. The UE of claim 1, wherein a quantity of bits in the subset of the second plurality of bits occurring in the first OOK symbol is equal to a quantity of bits in the subset of the first plurality of bits occurring in the first OOK symbol.

6. The UE of claim 1, wherein, to receive the wireless signaling, the one or more processors are individually or collectively operable to execute the code to cause the UE to:
receive the OFDM signal during a first portion of the plurality of OOK symbols, wherein the second plurality of bits comprises the reordering of the first plurality of bits occurs within the first portion of the plurality of OOK symbols.

7. The UE of claim 6, wherein the one or more processors are individually or collectively further operable to execute the code to cause the UE to:
ignore at least a portion of the OOK signal during at least a second portion of the plurality of OOK symbols occurring after the first portion of the plurality of OOK symbols.

8. The UE of claim 6, wherein the one or more processors are individually or collectively further operable to execute the code to cause the UE to:
enter a power saving mode during at least a second portion of the plurality of OOK symbols occurring after the first portion of the plurality of OOK symbols.

9. The UE of claim 6, wherein the OFDM signal located within the one or more on durations of the OOK signal comprises one of a plurality of candidate OFDM waveforms, each candidate OFDM waveform corresponding to respective portion of a bitstream.

10. The UE of claim 1, wherein, to receive the wireless signaling, the one or more processors are individually or collectively operable to execute the code to cause the UE to:
receive a first portion of the OOK signal during a first portion of the plurality of OOK symbols, the first portion of the OOK signal comprising a first portion of the first plurality of bits; and
receive a first portion of the OFDM signal during the first portion of the plurality of OOK symbols, the second portion of the OFDM signal comprising a first portion of the second plurality of bits.

11. The UE of claim 10, wherein the one or more processors are individually or collectively further operable to execute the code to cause the UE to:
combine the first portion of the first plurality of bits with the first portion of the second plurality of bits, wherein the first portion of the first plurality of bits comprises a first portion of the wireless message and the first portion of the second plurality of bits comprises a second portion of the wireless message according to the reordering, and wherein decoding the wireless message is based at least in part on the combining.

12. The UE of claim 10, wherein the one or more processors are individually or collectively further operable to execute the code to cause the UE to:
ignore a second portion of the OOK signal and a second portion of the OFDM signal during a second portion of the plurality of OOK symbols occurring after the first portion of the plurality of OOK symbols based at least in part on the receiving.

13. The UE of claim 10, wherein the one or more processors are individually or collectively further operable to execute the code to cause the UE to:
enter a power saving mode during a second portion of the plurality of OOK symbols occurring after the first portion of the plurality of OOK symbols.

14. The UE of claim 1, wherein the one or more processors are individually or collectively further operable to execute the code to cause the UE to:
receive control signaling indicating the reordering, wherein decoding the wireless message is based at least in part on the control signaling indicating the reordering.

15. The UE of claim 1, wherein the one or more processors are individually or collectively further operable to execute the code to cause the UE to:
enter a low power sleep mode according to a power saving configuration;
monitor for the wireless signaling comprising a low-power wakeup signal via a low-power wakeup radio according to a low power monitoring mode, wherein receiving the wireless signaling is based at least in part on the monitoring and the decoding occurs within a first portion of the plurality of OOK symbols based at least in part on the reordering; and
re-enter the low power sleep mode during a second portion of the plurality of OOK symbols occurring after the first portion of the plurality of OOK symbols.

16. A user equipment (UE), comprising:
one or more memories storing processor-executable code; and
one or more processors coupled with the one or more memories and individually or collectively operable to execute the code to cause the UE to:
receive a first wireless signal and a second wireless signal during a same time duration, wherein the first signal and the second signal each carry the same information; and
decode at least a portion of the first wireless signal, or at least a portion of the second wireless signal, or both.

17. The UE of claim 16, wherein:
the first wireless signal is received via first bandwidth, is scrambled according to a first scrambling sequence, is encoded according to a first encoding procedure, is modulated by a first modulation scheme, or any combination thereof; and
the second wireless signal is received via a second bandwidth that is different than the first bandwidth, is scrambled according to a second scrambling sequence that is different than the first scrambling sequence, is encoded according to a second encoding procedure that is different than the first encoding procedure, is modulated by a second modulation scheme that is different than the first modulation scheme, or any combination thereof.

18. The UE of claim 17, wherein the first modulation scheme comprises an on-off key (OFF) modulation scheme, and the second modulation scheme comprises an orthogonal frequency division modulation (OFDM) modulation scheme.

19. A method for wireless communications at a user equipment (UE), comprising:
monitoring for wireless signaling during a plurality of on-off keying (OOK) symbols;
receiving, based at least in part on the monitoring, the wireless signaling comprising an OOK signal comprising one or more on durations and one or more off durations within the plurality of OOK symbols and an orthogonal frequency division multiplexing (OFDM) signal located within one or more on durations of the OOK signal, the OOK signal indicating a first plurality of bits and the OFDM signal indicating a second plurality of bits, wherein the second plurality of bits comprises a reordering of the first plurality of bits, and wherein a subset of the second plurality of bits occurring in a first OOK symbol of the plurality of OOK symbols comprises a subset of the first plurality of bits occurring in a second OOK symbol of the plurality of OOK symbols that occurs after the first OOK symbol; and
decoding a wireless message comprising at least a portion of the first plurality of bits, at least a portion of the second plurality of bits, or both, based at least in part on receiving the wireless signaling comprising the OOK signal and the OFDM signal.

20. The method of claim 19, wherein the second plurality of bits comprises the first plurality of bits in reverse order according to the reordering such that the first plurality of bits comprises an ascending order of a set of bits and the second plurality of bits comprises a descending order of the set of bits.
